(19) United States
(12) Patent Application Publication
(10) Pub. No.: US 2026/0015475 A1
(43) Pub. Date: Jan. 15, 2026

(54) PRODUCTION OF POLYURETHANE FOAM

(71) Applicant: Evonik Operations GmbH, Essen (DE)

(72) Inventors: Michael Suchan, Gelsenkirchen (DE); Martin Glos, Borken (DE)

(73) Assignee: Evonik Operations GmbH, Essen (DE)

(21) Appl. No.: 19/264,002

(22) Filed: Jul. 9, 2025

(30) Foreign Application Priority Data
Jul. 12, 2024 (EP) 24188253.9

(51) Int. Cl. C08J 9/00; C08G 18/42; C08G 18/76; C08K 5/01; C08K 5/103; C08K 5/5419; C08L 75/06

(52) U.S. Cl. CPC C08J 9/0023; C08G 18/42; C08G 18/7671; C08J 9/0042; C08J 9/0061; C08K 5/01; C08K 5/103; C08K 5/5419; C08L 75/06; C08G 2110/0025; C08J 2203/14; C08J 2205/10; C08J 2375/06; C08J 2383/12; C08L 2203/14

(57) ABSTRACT

A composition for producing polyurethane foam contains a polyisocyanate component and a polyol component, wherein the composition additionally contains at least one organic compound V which contains at least one radical R^{A} selected from the group consisting of

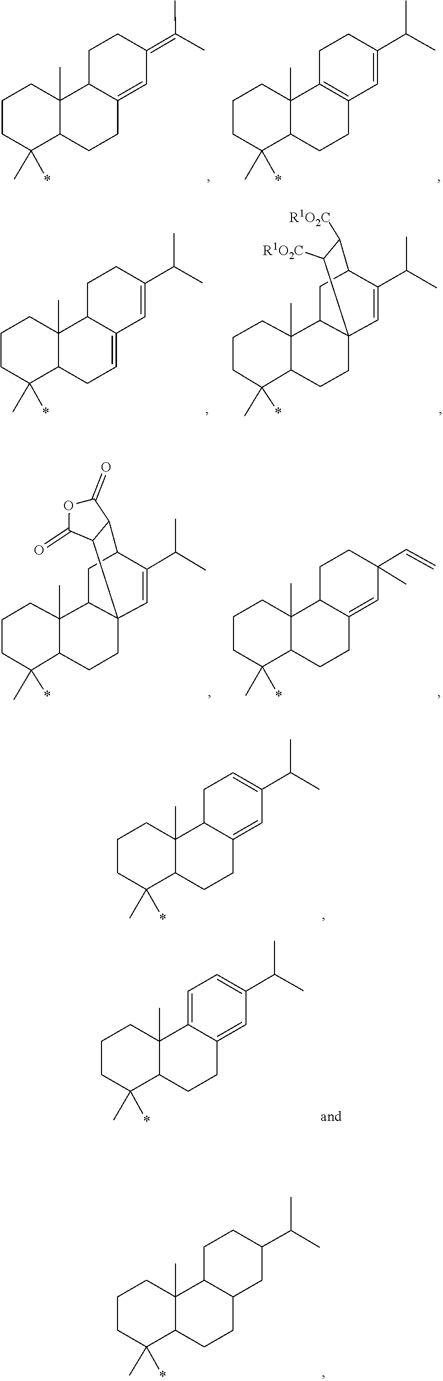

wherein * denotes the bond to the remaining portion of the at least one organic compound V, and wherein R¹ are independently of one another identical or different and selected from H or branched or linear alkyl radicals having 1 to 30 carbon atoms which optionally also contain heteroatoms.

### CROSS-REFERENCE TO RELATED APPLICATIONS

This patent application claims priority to European Patent Application No. 24188253.9, filed on Jul. 12, 2024, in the European Patent Office, the entire disclosure of which is hereby incorporated by reference herein.

### BACKGROUND OF THE INVENTION

### Field of the Invention

The present invention relates to the field of polyurethanes, especially that of polyurethane foams. It especially relates to a composition for producing polyurethane foam, to a process for producing polyurethane foam and also to the polyurethane foam produced by the process and the use thereof.

Polyurethane (PU) in the context of the present invention is in particular understood to mean a product obtainable through reaction of polyisocyanates and polyols or compounds having isocyanate-reactive groups. In addition to the polyurethane, further functional groups may also be formed here, for example uretdiones, carbodiimides, isocyanurates, allophanates, biurets, ureas and/or uretonimines. For the purposes of the present invention, therefore, PU is understood as meaning not just polyurethane, but also polyisocyanurates, polyureas, and polyisocyanate reaction products containing uretdione, carbodiimide, allophanate, biuret and/or uretonimine groups. In the context of the present invention, polyurethane foam (PU foam) is especially understood to mean foam obtained as a reaction product based on polyisocyanates and polyols or compounds having isocyanate-reactive groups. It is possible to form not only the eponymous polyurethane but also further functional groups, for example allophanates, biurets, ureas, carbodiimides, uretdiones, isocyanurates and/or uretimines, wherein isocyanurates are particularly preferred.

### Description of Related Art

The production of polyurethane foams may typically employ cell-stabilizing additives to ensure a fine-celled, uniform and low-defect foam structure and thus to exert an essentially positive influence on the performance characteristics, particularly the thermal insulation capacity, of the foam. Typically described in this context in the prior art are polyether-modified siloxanes (PES), especially for rigid foam applications. However, the use of Si-free surfactants is also described in the prior art.

Compared to Si-containing surfactants, especially compared to polyether-modified siloxanes (PES), Si-free surfactants may potentially lead to reduced foam qualities. Particularly when the PU foams are to achieve good insulation performance, i.e. a low lambda value, Si-containing surfactants, i.e. especially polyether-modified siloxanes (PES), may often have the advantage compared to Si-free surfactants.

However, the use of Si-containing surfactants, in particular of polyether-modified siloxanes (PES), can also have disadvantages. They may for instance impair the solubility of the blowing agents (for example pentanes) in the polyols. This can be particularly pronounced when the PES, for example, have a high siloxane content and are therefore strongly hydrophobic. In addition, the Si-containing surfactants are typically not based on renewable raw materials and are thus disadvantageous for sustainability reasons.

EP 2511328 A2 describes the use of carbamates as surfactant for foam stabilization. DE 1020011007479 A1 describes mixtures of acid amides with PES for use as foam stabilizers in rigid PU foam.

EP 1985642 A1 uses amido amines and imidazoles based on carboxylic acids and polyethylene- or polypropyleneamines, for example diethylenetriamine, triethylenetetramine or tetraethylenepentamine, as additives for the production of PU foams.

U.S. Pat. No. 3,746,663 describes the use of N-vinylpyrrolidone-based structures for use as surfactant in PU foam production.

DE 3724716 C1 describes the use of novolak-based ethoxylates as stabilizers in PU foam production.

WO 95/16721 A1 describes the production of PU foams using polyalkylene oxides, wherein the polyalkylene oxides are preferably formed using 10-90% butylene oxide.

EP 1985642 A1 describes a composition for production of PU foam using amide amides and/or imidazoles based on C1-C36 carboxylic acids.

U.S. Pat. No. 5,236,961 describes the production of polyurethane foams using alkylphenol ethoxylates as foam stabilizers.

DE 2244350 A1 describes the use of copolymers preferably produced from N-vinylpyrrolidone and maleic esters for production of polyurethane foam.

The use of Si-free surfactants in PU foams is thus known from the prior art.

However, there is still a need for further Si-free surfactants. It would be particularly desirable, for example, to have Si-free surfactants based on renewable raw materials, wherein these raw materials preferably also have no application in the food sector to prevent any competitive scenario.

A large proportion of the aforementioned Si-free surfactants are based on fatty acids of animal or vegetable origin such as for example: pork fat, beef tallow, goose fat, duck fat, chicken fat, horse fat, whale oil, fish oil, palm oil, olive oil, avocado oil, seed oils, coconut oil, palm kernel oil, cocoa butter, cotton seed oil, pumpkin seed oil, corn germ oil, sunflower oil, wheat germ oil, grape seed oil, sesame oil, flaxseed oil, soybean oil. Chemically, these are linear, partially unsaturated, carboxylic acids having different chain lengths that are derivatized in a very wide variety of ways.

Besides the use of Si-free surfactants in PU foams, the use of hydrocarbons in PU foams is also very well known. Hydrocarbons are thus often used in PU foams as a blowing agent for example. Compounds having at most 7 and especially 3 to 7 carbon atoms may be employed since these have boiling points in the appropriate temperature range with the result that they evaporate in the foaming process and thus contribute to an increase in volume, i.e. to foam formation. These blowing agents then remain present as cell gas in the finished foam. The use of these hydrocarbons is described in numerous documents.

US 2011/0218259 A1 describes the use of cyclopentane in rigid PU foam systems having improved flowability, such as is required for example in the production of refrigeration equipment or panels.

DE3933335 A1 describes the use of cyclopentane and mixtures thereof with cyclohexane and various hydrocarbons having at most 4 carbons and ethers and fluoroalkanes having a boiling point of less than 35° C. DE3933335 A1 thus employs hydrocarbons that all evaporate during PU foaming and thus serve as blowing agents.

WO 2016/202912 A1 describes various hydrocarbons as well as ethers, ketones, esters, acetals and fluoroalkanes as blowing agents, wherein the boiling points are preferably below 50° C.

CN 101880452 A describes the use of alkanes having 14 to 21 carbons as phase transition material which is used as filler in amounts of 10 to 30 parts per 100 parts of polyol. There is no description here of any effects on the quality of a PU foam produced therewith with regard to its thermal conductivity.

JPH09165427 A describes the use of alkanes having 9 to 12 carbons which serve to improve the storage stability of the polyol mixture specifically for the case where pentane is used as blowing agent. JPH09165427 A uses 1 to 10 parts of the alkanes based on 100 parts of polyol. There is no description here of any effects on the quality of a PU foam produced therewith with regard to its thermal conductivity.

US 20070066697 A1 describes flexible PU foams which achieve a better compressive strength by using hydrocarbons having 10 to 70 carbon atoms, wherein the hydrocarbons are preferably added in amounts of 0.01 to 100 pphp (pphp=parts per hundred parts of polyol).

JPH 0418431 A describes the use of unreactive components, for example paraffins or other hydrocarbons, which are added in amounts of 0.1 to 10 pphp in rigid PU foam and which are said to improve the ageing of the foam with regard to the lambda value. The examples of JPH 0418431 A show that the initial lambda values are impaired upon addition of paraffin.

EP 3677610 A1 describes the use of specific hydrocarbons in combination with polyether-modified siloxanes as surfactants to obtain rigid PU foams with improved properties. This combination is disclosed as obligatory. EP 3677610 A1 does not describe any option for achieving improved properties of rigid PU foams with organic compounds V, such as are more precisely defined below.

The use of polyalkylsiloxanes from the prior art is also known, as described for example in WO2020/144003 A1.

The specific object of the present invention was that of enabling the provision of PU foams using further Si-free surfactants.

In the context of the present invention it has surprisingly been found that the object can be achieved by the use of at least one organic compound V as more precisely defined below.

Such organic compounds V as more precisely defined below preferably include abietic acid and/or certain derivatives thereof.

Abietic acid is a resin acid. It can, for example, be obtained from tree resin. Abietic (acid) derivatives are known from the prior art. The prior art describes the production of polyester polyols as a use of abietic (acid) derivatives.

U.S. Pat. No. 4,758,379 describes the production of abietic acid esters, preferably with DEG, TEG, EG, PG or even pentaerithritol. However, no uses of the obtained esters are described in U.S. Pat. No. 4,758,379.

WO 2019/006431 A1 describes the production of resin acid esters having a low colour number and the use thereof in road markings and adhesive compositions. In particular, WO 2019/006431 A1 describes a method for producing a rosin with light colour and a method for producing a rosin ester with light colour.

CN 110387027 A describes the production of a spray foam based on renewable raw materials employing inter alia an abietic ester polyol as the polyol component.

WO 2019/177903 A1 describes producing a flexible foam having a longer recovery time by employing a tackifier and no physical blowing agents. The foam in WO 2019/177903 A1 is an open-celled flexible foam.

CN 103709357 A describes abietic acid polyols having an OH number of 400 to 460 mg KOH/g. These high OH numbers are necessary for use as a polyol. Use as a surfactant is not described in CN 103709357 A.

EP 2677030 A1 also describes tall oil/abietic acid-based polyols which are produced by amidation with DEA or esterification with TEA. EP 2677030 A1 does not describe use as a surfactant either.

CN 101045785 also describes abietic acid-based polyols having OH numbers from 250 to 500 mg KOH/g. Use as a surfactant is not described in CN 101045785.

CN 101029124 describes abietic acid-based polyols based on dimer-abietic acid or phenol-abietic acid. Use as a surfactant is not described in CN 101029124.

### SUMMARY OF THE INVENTION

The specific object of the present invention is achieved by the subject matter of the invention. The invention provides a composition for producing polyurethane foam comprising a polyisocyanate component, a polyol component, optionally at least one catalyst that catalyses the formation of a urethane or isocyanurate bond and optionally at least one blowing agent,
wherein the composition additionally comprises at least one organic compound V comprising at least one radical R^{A} selected from the group consisting of,

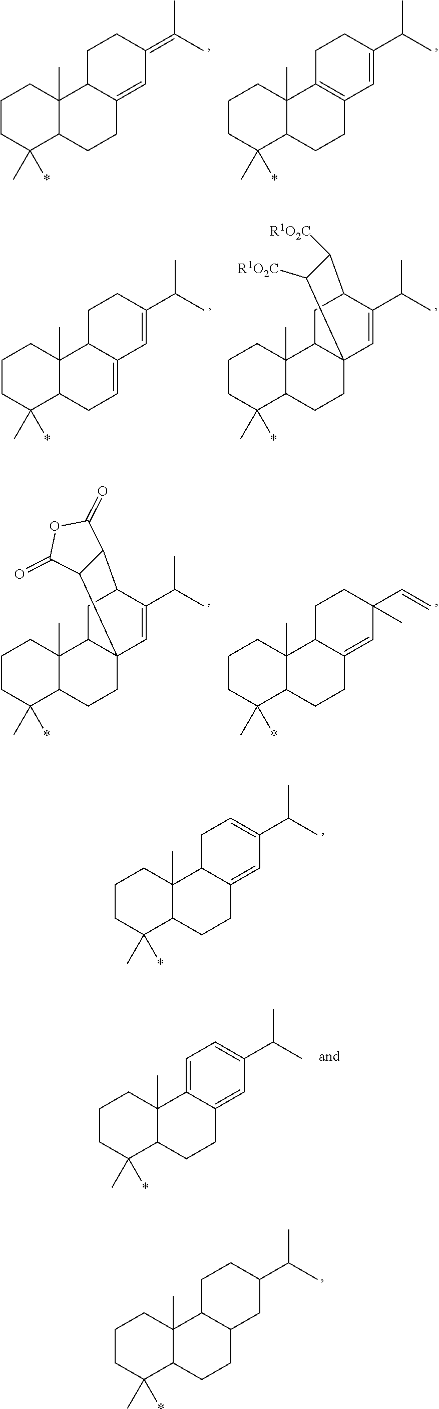

wherein * denotes the bond to the remaining portion of the organic compound V,
and wherein
R¹ are independently of one another identical or different and selected from H or branched or linear alkyl radicals having 1 to 30 carbon atoms which may also contain heteroatoms such as preferably O and/or N.

The invention includes but is not limited to the following embodiments:
1. A composition for producing polyurethane foam, the composition, comprising:
a polyisocyanate component,
a polyol component,
optionally at least one catalyst that catalyses a formation of a urethane or isocyanurate bond, and
optionally at least one blowing agent,
wherein the composition additionally comprises at least one organic compound V comprising at least one radical R^{A} selected from the group consisting of

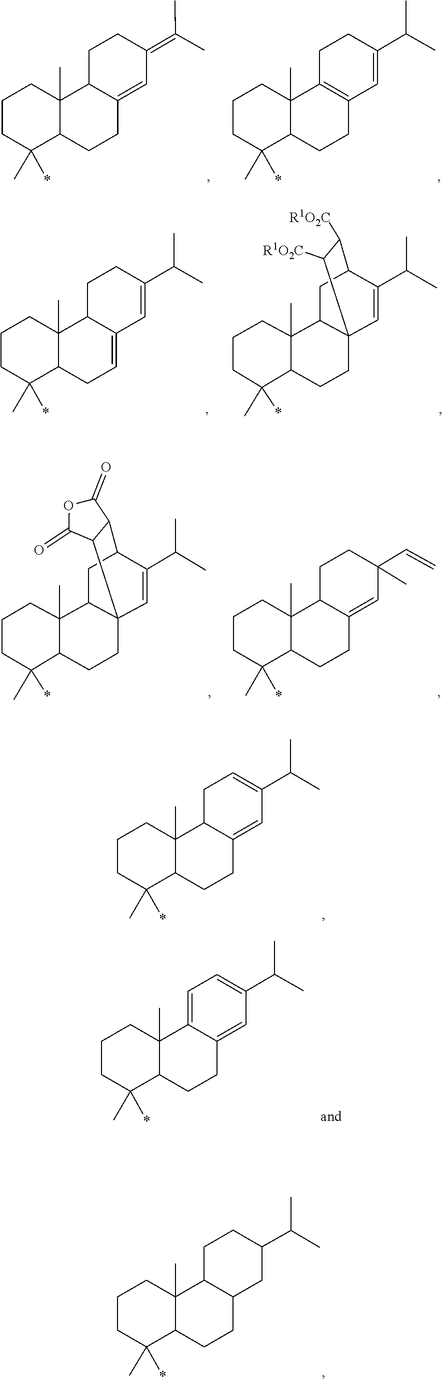

wherein * denotes a bond to a remaining portion of the at least one organic compound V,
and wherein
R¹ are independently of one another identical or different and selected from 1-1 or branched or linear alkyl radicals having 1 to 30 carbon atoms which optionally also contain heteroatoms.
2. The composition according to Embodiment 1, wherein the at least one organic compound V is selected from the group consisting of

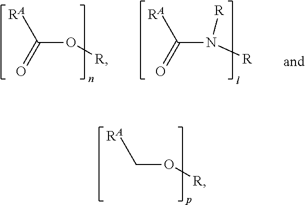

wherein
n=1 to 5,
l=1 to 5,
p=1 to 5,
R are independently of one another identical or different and selected from H or branched or linear alkyl radicals having 1 to 30 carbon atoms which optionally also contain heteroatoms,
R^{A} are independently of one another identical or different radicals selected from the group consisting of

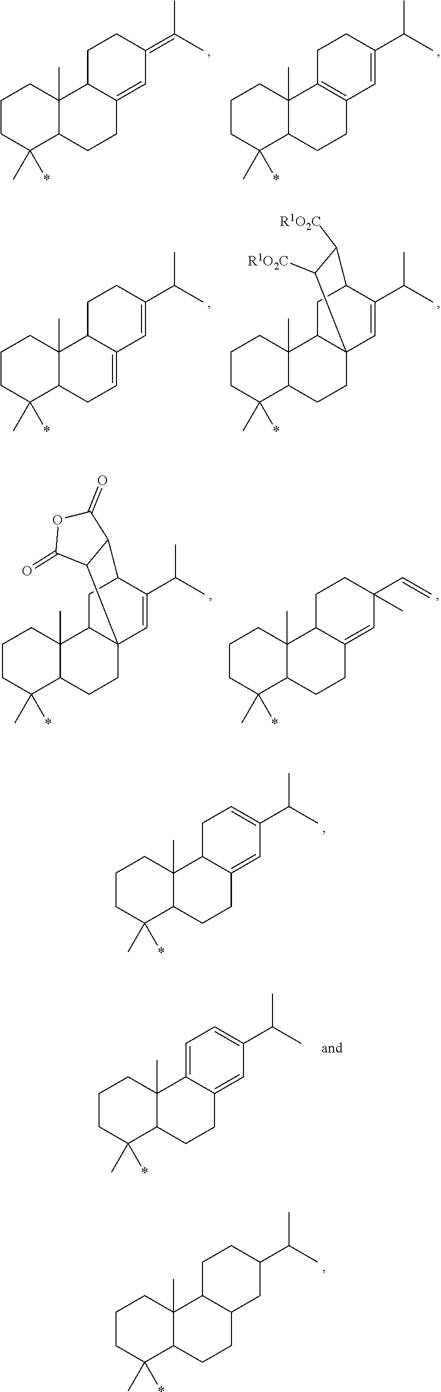

wherein * denotes the bond to the remaining portion of the at least one organic compound V.
and wherein
R¹ are independently of one another identical or different and selected from H or branched or linear alkyl radicals having 1 to 30 carbon atoms which optionally also contain heteroatoms.
3. The composition according to Embodiment 1, wherein the at least one organic compound V is selected from the group consisting of

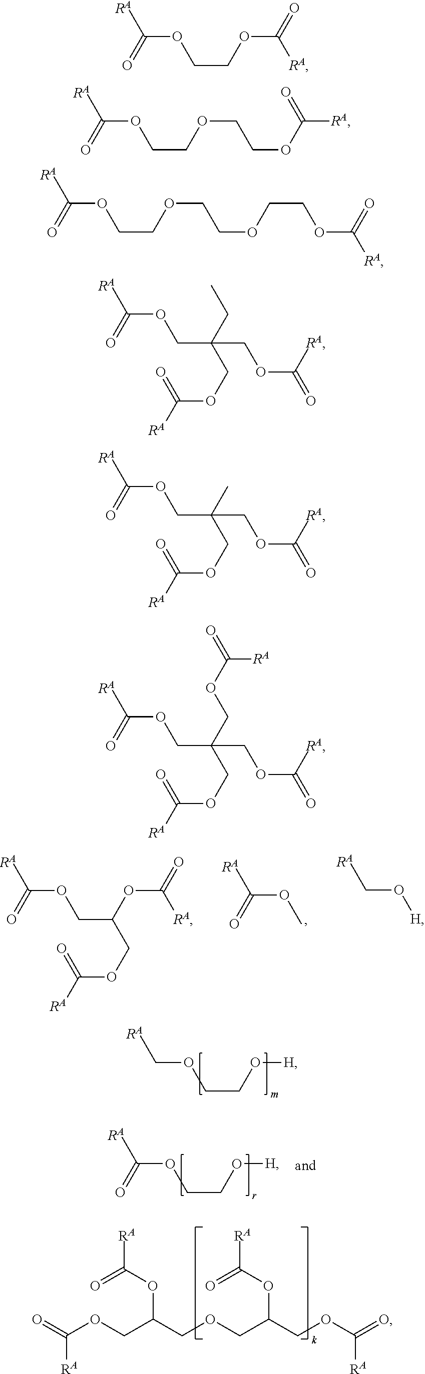

wherein
R^{A} are independently of one another identical or different radicals selected from the group consisting of

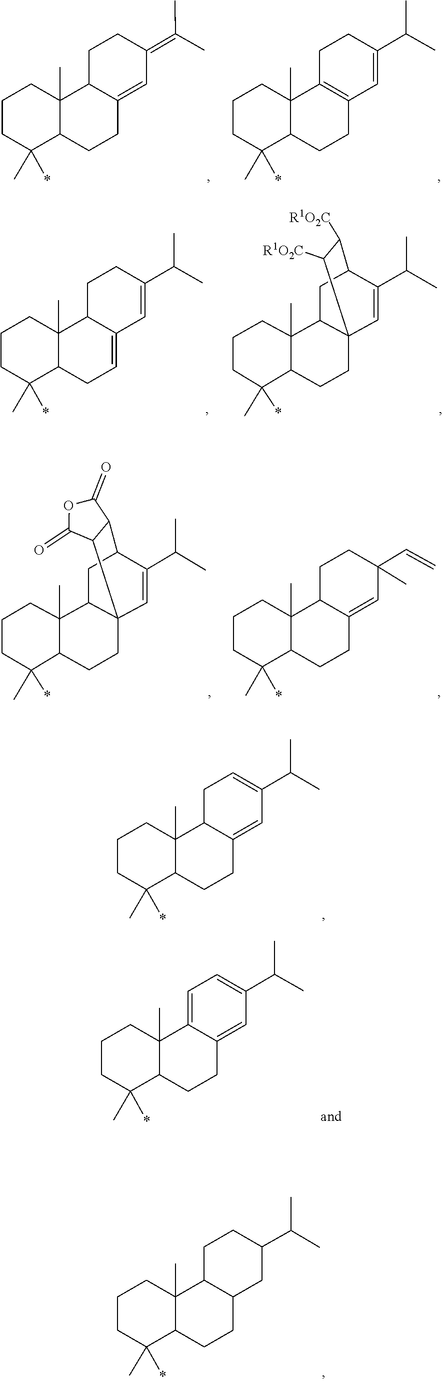

wherein * denotes the bond to the remaining portion of the organic compound V and wherein

$$m = 1 to 15 ,$$

$$r = 1 to 15$$

$$k = 1 to 6 ,$$

R¹ are independently of one another identical or different and selected from H or branched or linear alkyl radicals having 1 to 30 carbon atoms which optionally also contain heteroatoms.
4. The composition according to Embodiment 1, wherein the at least one organic compound V has an OH number of less than 150 mg KOH/g.
5. The composition according to Embodiment 1, further comprising:
at least one hydrocarbon HC having 10 to 24 carbon atoms and a boiling point>100° C. at a pressure of 1.01325 bar,
wherein altogether present hydrocarbon HC in combination with altogether present organic compound V are employed in a mass ratio of 1:5 to 1:200.
6. The composition according to Embodiment 1, further comprising:
at least one polyalkylsiloxane PAS which comprises no polyether modification and contains less than 20 Si atoms,
wherein altogether employed polyalkylsiloxane PAS is employed in a mass ratio of 1:4 to 1:200 based on altogether employed organic compound V and
the at least one polyalkylsiloxane PAS conforms to formula 1:

MₐD_{b}T_{c}Q_{d} (formula 1)
where

$$M = {R}^{11} {R}^{12} {R}^{13} {SiO}_{1 / 2}$$

$$D = {R}^{14} {R}^{15} {SiO}_{2 / 2}$$

$$T = {R}^{16} {SiO}_{3 / 2}$$

$$Q = {SiO}_{4 / 2}$$

wherein
R¹¹, R¹², R¹³, R¹⁴, R¹⁵, R¹⁶ are independently of one another identical or different hydrocarbon radicals having 1 to 12 carbon atoms, wherein the hydrocarbon radicals are optionally substituted with heteroatoms or H,
and wherein

$$a = 2 to 6$$

$$b = 0 to 8$$

$$c = 0 to 4$$

$$d = 0 to 2 ,$$

with the proviso that a+b+c+d<20,
wherein
R¹⁶ is different from R¹¹, R¹², R¹³, R¹⁴ and R¹⁵,
and/or R¹¹, R¹² and R¹³ are different.
7. The composition according to Embodiment 1, wherein an usage amount of the altogether employed organic compound V based on 100 parts by mass of the total polyol component is from 0.1 to 10 parts by mass.
8. The composition according to Embodiment 5, wherein an usage amount of altogether employed hydrocarbon HC, altogether employed organic compound V and optionally altogether employed polyalkylsiloxane PAS based on 100 parts by mass of the total polyol component is from 0.1 to 10 parts by mass.
9. The composition according to Embodiment 1, further comprising:
at least one polyether-modified siloxane.
10. The composition according to Embodiment 1, wherein a ratio of altogether employed polyisocyanate component and altogether employed polyol component expressed as an index of a formulation is in the range from 150 to 550.
11. The composition according to Embodiment 1, wherein the altogether employed polyol component comprises at least one polyester polyol.
12. The composition according to Embodiment 1, comprising:
at least one blowing agent.
13. A process for producing polyurethane foam by reacting a polyol component with a polyisocyanate component, the process comprising:
carrying out the reaction in presence of at least one organic compound V as defined in Embodiment 1.
14. A polyurethane foam obtainable by the process according to Embodiment 13.
15. A composition for insulation purposes, the composition comprising:
The polyurethane foam according to Embodiment 14.
16. A process, comprising:
producing a polyurethane foam with the at least one organic compound V as defined in Embodiment 1.

### DETAILED DESCRIPTION OF THE INVENTION

The present invention accordingly makes it possible to provide PU foam, especially rigid PU foam. It has surprisingly been found that the use of the at least one organic compound V makes it possible to further expand the range or spectrum of the Si-free surfactants employable for production of PU foam. The invention can thus also advantageously contribute to producing PU foam-based products such as for example insulation panels or refrigeration equipment.

A further advantage of the invention is for example that it is preferably also possible to use the at least one organic compound V in combination with other surfactants, for example with polyether-modified siloxanes and/or other Si-free surfactants.

The invention advantageously makes it possible to obtain PU foam having at least sufficient or advantageous quality with regard to pore structure for example and/or with regard to insulation performance for example.

It is particularly preferable when the at least one organic compound V is selected from the group consisting of

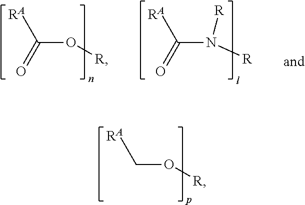

wherein

$$n = 1 to 5 ,$$

$$l = 1 to 5 ,$$

$$p = 1 to 5 ,$$

R are independently of one another identical or different and selected from H or branched or linear alkyl radicals having 1 to 30 carbon atoms which may also contain heteroatoms such as preferably O and/or N,
R^{A} are independently of one another identical or different radicals selected from the group consisting of

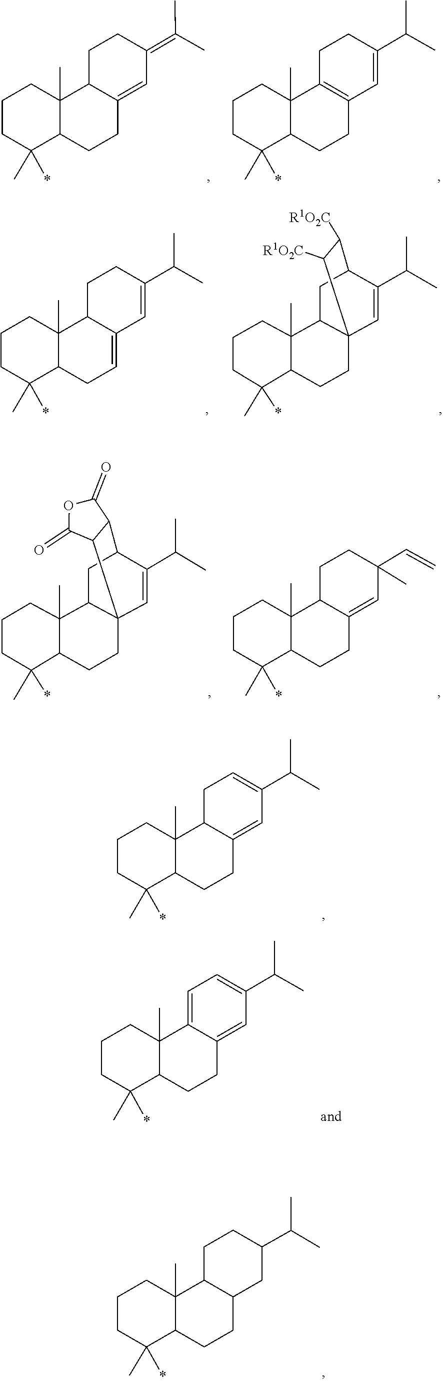

wherein * denotes the bond to the remaining portion of the organic compound V,
and wherein
R¹ are independently of one another identical or different and selected from H or branched or linear alkyl radicals having 1 to 30 carbon atoms which may also contain heteroatoms such as preferably O and/or N.

Also shown here for further elucidation as a possible example of a possible organic compound V is a diester of monoethylene glycol,

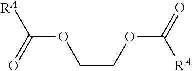

where R^{A} is as defined above.

The case where R^{A} is

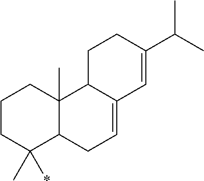 [SMILES: *C1(C)CCCC2(C)C3CCC(C(C)C)=CC3=CCC12]

for example would lead in such an exemplary case to the following complete structural formula:

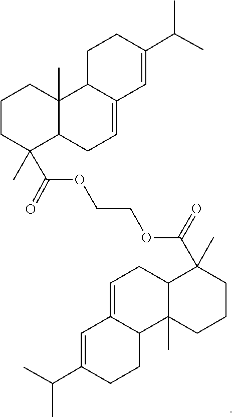 [SMILES: CC(C)C1=CC2=CCC3C(C)(C(=O)OCCOC(=O)C4(C)CCCC5(C)C6CCC(C(C)C)=CC6=CCC45)CCCC3(C)C2CC1]

This shows for example how the structures R^{A} are integrated into the organic compounds V.

It is particularly preferable when the at least one organic compound V is selected from the group consisting of

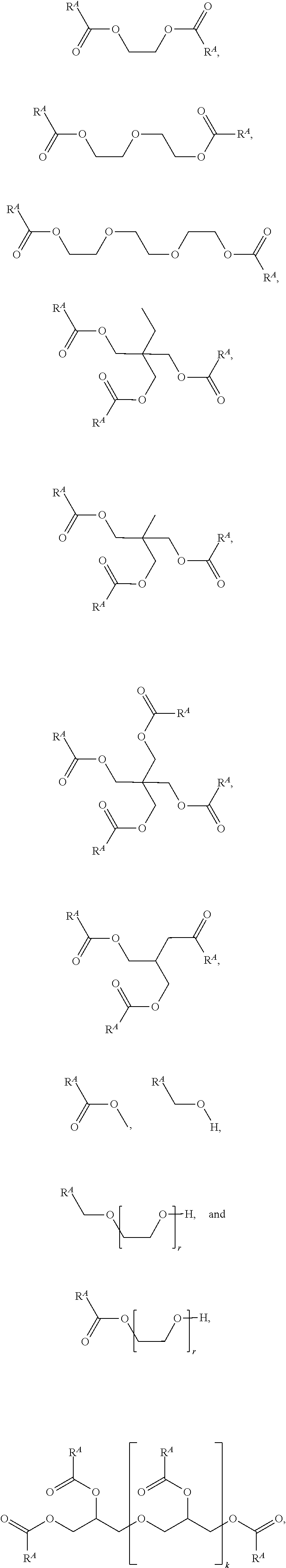

wherein

$$m = 1 to 15 ,$$

$$r = 1 to 15 ,$$

$$k = 1 to 6 ,$$

R^{A} are independently of one another identical or different radicals selected from the group consisting of

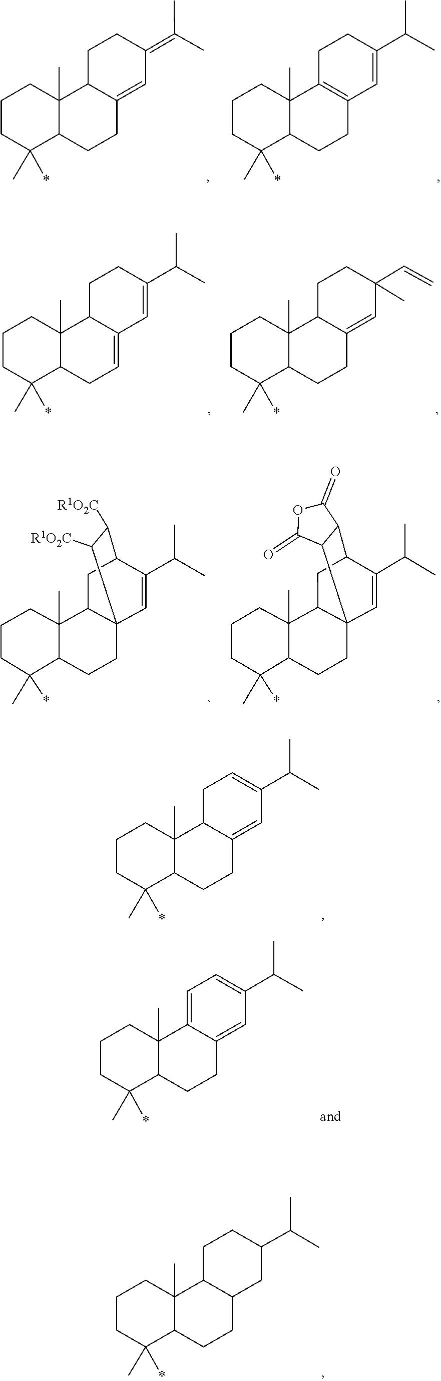

wherein * denotes the bond to the remaining portion of the organic compound V,
and wherein
R¹ are independently of one another identical or different and selected from H or branched or linear alkyl radicals having 1 to 30 carbon atoms which may also contain heteroatoms such as preferably O and/or N,
wherein the diethylene glycol ester, the triethylene glycol ester, the polyglycerol ester, abietol, hydrogenated abietol and/or partially hydrogenated abietol are very particularly preferred.

The structural formula of abietol is

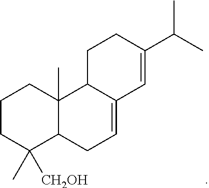 [SMILES: CC(C)C1=CC2=CCC3C(C)(CO)CCCC3(C)C2CC1]

The at least one organic compound V preferably has an OH number less than 150, preferably less than 100, particularly preferably less than 50 mg KOH/g.

It is thus preferable when any secondary constituents generated during production of the organic compound V which may have a higher OH number are preferably only present in correspondingly small proportions, if at all. It is particularly preferable when such secondary constituents are not present at all. For example production of monoethylene glycol ester may possibly generate

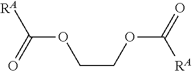

as a secondary constituent the monoester having the formula

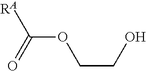

whose OH number according to the formula is calculated as 162 mg KOH/g.

In order therefore to achieve the preferred OH numbers of less than 150 mg KOH/g it is preferable when corresponding 01 function-bearing secondary constituents which may be generated during production of the organic compound V are present only in correspondingly low proportions, if at all. It is preferable when such secondary constituents are not present at all.

The production of particularly preferred organic compounds V may be effected for example on the basis of esterifications, for example of glycols, glycerol, polyglycerol and/or pentaerythritol with carboxylic acids of general formula R^{A}CO₂H, wherein care is preferably taken to ensure that the reaction is operated in such a way that preferably very few free OH groups remain in the product so that the product thus preferably has a correspondingly low OH number.

Preferred organic compounds V are for example the following carboxylic acids conforming to the general formula R^{A}CO₂H,

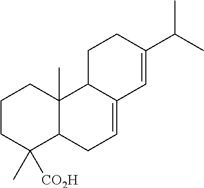

abietic acid,

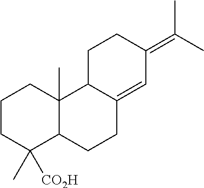 [SMILES: CC(C)=C1C=C2CCC3C(C)(C(=O)O)CCCC3(C)C2CC1]

neoabietic acid,

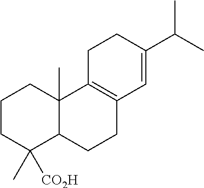 [SMILES: CC(C)C1=CC2=C(CC1)C1(C)CCCC(C)(C(=O)O)C1CC2]

palustric acid,

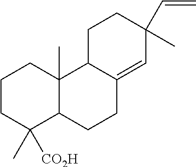 [SMILES: C=CC1(C)C=C2CCC3C(C)(C(=O)O)CCCC3(C)C2CC1]

pimaric acid,

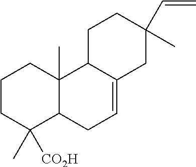 [SMILES: C=CC1(C)CCC2C(=CCC3C(C)(C(=O)O)CCCC23C)C1]

isopimaric acid,

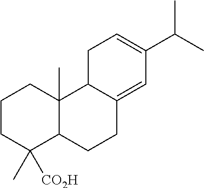 [SMILES: CC(C)C1=CCC2C(=C1)CCC1C(C)(C(=O)O)CCCC21C]

levopimaric acid,

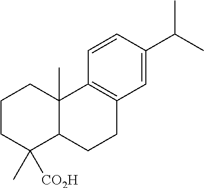 [SMILES: CC(C)c1ccc2c(c1)CCC1C(C)(C(=O)O)CCCC21C]

dehydroabietic acid and/or

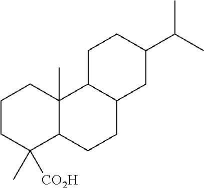 [SMILES: CC(C)C1CCC2C(CCC3C(C)(C(=O)O)CCCC23C)C1]

tetrahydroabietic acid,

and preferably the reaction products of these carboxylic acids, for example in the context of esterification with glycols, glycerol, polyglycerol and/or pentaerythritol, or for example in the context of amidation. Particular preference is given to the reactions to afford for example esters, amides, imides, imidazolines and/or oxazolines.

Preferred organic compounds V are for example the corresponding ethylene glycol carboxylic esters, diethylene glycol carboxylic esters, triethylene glycol carboxylic esters, glycerol carboxylic esters, pentaerythritol carboxylic esters, trimethylolethane carboxylic esters, trimethylolpropane carboxylic esters, sucrose carboxylic esters, sorbitan carboxylic esters and/or polyglycerol carboxylic esters, wherein carboxylic esters are presently to be understood as meaning the corresponding esters of the carboxylic acids of general formula R^{A}CO₂H.

It is possible to use different alcohols for esterification, for example butyl glycol, ethyl glycol and/or other monools, as well as species having a plurality of OH functions, for example polyglycerols, sucrose, sorbitols, propylene glycol, dipropylene glycol and/or polyalkylene glycols.

The at least one organic compound V employed is preferably selected for example from alcohol alkoxylates, preferably abietol alkoxylates, for example produced by reaction of alkylene oxides with abietol. Ethoxylates and/or propoxylates of abietol are preferred. Suitable alcohol alkoxylates are more particularly described below.

It is preferably also possible to employ for example carboxylic amides as the at least one organic compound V. Such amides may be produced for example on the basis of amines and preferably the aforementioned carboxylic acids of general formula R^{A}CO₂H.

Amines that may be suitable include for example those which have at least one primary or secondary amine function for amidation and may optionally contain one or more hydroxy groups. Suitable amines thus include for example: ethylenediamine, diethylenetriamine (DETA), triethylenetetramine (TETA), tetraethylenepentamine (TEPA), dipropylenetriamine, tripropylenetetramine, tetrapropylenepentamine, pentapropylenehexamine, hexapropyleneheptamine, and also higher homologues based on ethylenediamine or propylenediamine, 1,2-propylenediamine, 4,4′-diaminodicyclohexylmethane, 3,3′-dimethyl-4,4′-diaminodicyclohexylmethane, 4,4-methylenediphenylenediamine, isophoronediamine, trimethylhexylmethylenediamine, neopentanediamine, octamethylenediamine, polyetheramines such as Polyetheramine D 2000 (BASF), Polyetheramine D 230 (BASF), Polyetheramine T 403 (BASF), Polyetheramine T 5000 (BASF) or corresponding Jeffamine types from Huntsman, piperazine, aminoethylpiperazine, bis(aminoethyl)piperazine, 1,3-diaminopropane, 3-(cyclohexylamino)propylamine, 3-(methylamino)propylamine, dimethylaminopropylamine (DMAPA), N,N-bis(3-aminopropyl)methylamine, (3-(2-aminoethylamino)propylamine), dipropylenetriamine and/or N,N′-bis(3-aminopropyl)ethylenediamine.

Suitable hydroxylamines having at least one OH function may include for example: ethanolamine, propanolamine, alkylethanolamines, arylethanolamine, alkylpropanolamine, such as for example: diethanolamine, monoethanolamine, diisopropanolamine, isopropanolamine, methylisopropanolamine, diglycolamine (2-(2-aminoethoxy)ethanol), dimethylethanolamine, N-(2-hydroxyethyl)aniline, 1-(2-hydroxyethyl)piperazine, 2-(2-aminoethoxy)ethanol, 3-amino-1-propanol, 5-amino-1-pentanol, butylethanolamine, ethylethanolamine, N-methylethanolamine, aminopropylmonomethylethanolamine, 2-amino-2-methylpropanol, trishydroxymethylaminomethane (THMAM or TRIS), N-(2-aminoethyl)ethanolamine (AEEA). It is also possible to use corresponding alkoxylates, especially ethoxylates and/or propoxylates of amines, for example alkylamines having a hydroxyethyl or hydroxypropyl unit or, for example, N-hydroxyethylcyclohexyldiamine, N-hydroxyethylisophoronediamine, N-hydroxyethylpiperazine and/or bis(hydroxyethyl)toluenediamine.

It is preferably also possible for example to employ alcohol alkoxylates as the at least one organic compound V. Processes for producing alcohol alkoxylates are known to those skilled in the art. The alcohol alkoxylates may preferably be obtained by reacting abietol with alkylene oxides. An abietol alkoylate producible by reaction of abietol with alkylene oxides may be preferable for example. The alkylene oxides undergo addition onto the alcohol by ring opening. The alkylene oxides are preferably selected from the group consisting of ethylene oxide (EO), propylene oxide (PO), butylene oxide (BO) and styrene oxide (SO). The alkylene oxides may be added either individually in pure form, in alternating succession in any metering sequence, or else simultaneously in mixed form. This determines the sequence of the oxyalkylene units or alkyleneoxy units as repeating units in the polyether chain that forms. By the process, it is possible to construct polyether chains having the feature of controlled and reproducible preparability in terms of structure and molar mass. The sequence of repeating units can be varied by the sequence of addition of the alkylene oxides within broad limits. Production of the alcohol alkoxylates preferably comprises reacting alkylene oxide units selected from the group consisting of ethylene oxide (EO), propylene oxide (PO), butylene oxide (BO) and styrene oxide (SO), wherein it is preferable to use an average of 3 to 150 alkylene oxide units per hydroxy group of the alcohol.

It is preferable when the at least one organic compound V is selected from the group consisting of esters, amides, imides, imidazolines, oxazolines and polyether compounds. A preferred polyether compound has at least 2, preferably 2 to 100, especially 3 to 50, ether groups.

Preferably employable organic compounds V may be, for example, derivatives of abietic acid,
for example esters of abietic acid

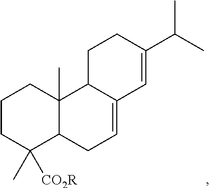

for example amides of abietic acid:

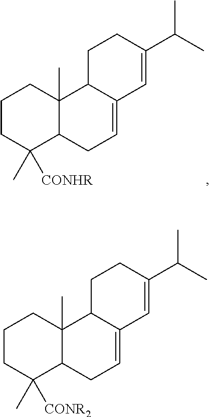

for example abietol

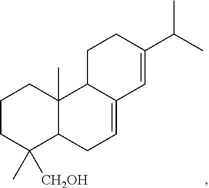

wherein
R are independently of one another identical or different and selected from H or branched or linear alkyl radicals having 1 to 30 carbon atoms which may also contain heteroatoms such as preferably O and/or N.

The composition according to the invention may preferably comprise further components. It is thus preferable when the composition according to the invention additionally comprises at least one hydrocarbon HC which preferably has 10 to 24 carbon atoms and has a boiling point>100° C., preferably >150° C., at a pressure of 1.01325 bar (standard pressure), particularly preferably selected from the group consisting of decene, decane, isodecane, isodecene, undecene, undecane, isoundecane, isoundecene, dodecene, dodecane, isododecane, isododecene, tridecane, tridecene, isotridecane, isotridecene, tetradecane, tetradecene, isotetradecane, isotetradecene, pentadecane, pentadecene, isopentadecane, isopentadecene, hexadecane, hexadecene, isohexadecane, isohexadecene, heptadecane, heptadecene, isoheptadecane, isoheptadecene, octadecane, octadecene, isooctadecane, isooctadecene, nonadecane, nonadecene, isononadecane, isononadecene, eicosane, eicosene, isoeicosane, isoeicosene, tributene, tributane, tetrabutene, tetrabutane, alkylbenzenes having at least 10 carbon atoms and oxo oils, wherein altogether present hydrocarbon HC in combination with altogether present organic compound V are preferably employed in a mass ratio of 1:5 to 1:200.

It has been found that the additional use of at least one hydrocarbon HC can lead to further improved properties of PU foams in the context of the invention.

It is particularly preferable when the boiling points of hydrocarbons HC employable according to the invention are below 400° C., preferably below 350° C., at standard pressure (i.e. at a pressure of 1.01325 bar). Preferably employable hydrocarbons HC thus preferably have boiling points of >100° C. to <400° C., especially of >100° C. to <350° C., at standard pressure (1.01325 bar). The hydrocarbons HC consist of carbon atoms, hydrogen atoms and optionally at most 3 heteroatoms selected from the group consisting of oxygen, nitrogen and sulfur atoms. Preferably, the hydrocarbons HC, if they do contain heteroatoms, comprise only oxygen atoms as heteroatoms. It is preferable for the hydrocarbons HC to have one heteroatom or no heteroatoms, where the heteroatom, when they have one, is an oxygen atom. However, it is yet more preferable for the hydrocarbons HC not to have any heteroatoms. It is thus particularly preferable for the hydrocarbons HC to consist exclusively of carbon atoms and hydrogen atoms. Both saturated and unsaturated hydrocarbons HC may preferably be employed. Aliphatic or aromatic hydrocarbons HC may preferably be employed. The hydrocarbons HC may be branched or unbranched. They may be cyclic or acyclic hydrocarbons HC.

Particularly preferred hydrocarbons HC are olefins, paraffins, isoparaffins and/or alkylbenzenes. Such materials are available, for example, from Sasol under the following trade names: HF®1000, LINPAR®, SASOLAB®, PARAFOL®.

The hydrocarbons HC preferably employable according to the invention are preferably hydrocarbons (branched or unbranched, saturated or unsaturated, cyclic or acyclic, aliphatic) having 10 to 24 carbon atoms. These are producible for example by oligomerization of olefins as described for example in U.S. Pat. No. 4,647,707, DE102008007081A1 or DE102013212481A1.

It is likewise also possible, for example, to employ corresponding material streams generated in the production of oxo alcohols, as described for example in U.S. Pat. No. 4,647,707, EP1515934B1 or EP2947064A1. This generates intermediates or byproducts known as oxo oils. Preference is given here to paraffin- and olefin-containing distillation fractions, for example so-called light oxo fraction, as described for example in U.S. Pat. No. 4,647,707.

Very particularly preferred hydrocarbons HC employable according to the invention are selected from the group consisting of decene, decane, isodecane, isodecene, undecene, undecane, isoundecane, isoundecene, dodecene, dodecane, isododecane, isododecene, tridecane, tridecene, isotridecane, isotridecene, tetradecane, tetradecene, isotetradecane, isotetradecene, pentadecane, pentadecene, isopentadecene, hexadecene, hexadecene, isohexadecane, isohexadecene, heptadecane, heptadecene, isoheptadecane, isoheptadecene, octadecane, octadecene, isooctadecane, isooctadecene, nonadecane, nonadecene, isononadecane, isononadecene, eicosane, eicosene, isoeicosane, isoeicosene, tributene, tributane, tetrabutene, tetrabutane, alkylbenzenes having at least 10 carbon atoms and oxo oils.

Preferably employable hydrocarbons HC are available for example as C4 oligomers such as tributene, tetrabutane and/or tetrabutene. Preferably employable hydrocarbons HC are for example the following commercially available products designated as intermediates and byproducts: oxo oil HS 9, oxo oil LS 9 and/or oxo oil LS 13 from Evonik Performance Intermediates.

It is likewise possible, for example, to employ hydrocarbons HC produced from renewable raw materials, such as for example isododecane from Global Bioenergies (Evry Courcouronnes, France) which can be produced for example by the process described in WO 2021/228824.

Preferably employable hydrocarbons HC include for example those which have no aromatic units and are composed of 9 to 21 carbon atoms.

It is preferable when the composition according to the invention additionally comprises at least one polyalkylsiloxane PAS which comprises no polyether modification and preferably contains less than 20, more preferably less than 15, particularly preferably less than 11, Si atoms, wherein altogether employed polyalkylsiloxane PAS is preferably employed in a mass ratio of 1:4 to 1:200 based on altogether employed organic compound V. It is preferable when the at least one polyalkylsiloxane PAS has at least 2 Si atoms.

When in the context of the present invention reference is made to “polyalkylsiloxane PAS” this always refers to polyalkylsiloxane or polyalkylsiloxane PAS comprising no polyether modification.

It is preferable when the at least one polyalkylsiloxane PAS conforms to formula 1:

$${M}_{a} {D}_{b} {T}_{c} {Q}_{d} \qquad ( formula 1 )$$

where

$$M = {R}^{11} {R}^{12} {R}^{13} {SiO}_{1 / 2}$$

$$D = {R}^{14} {R}^{15} {SiO}_{2 / 2}$$

$$T = {R}^{16} {SiO}_{3 / 2}$$

$$Q = {SiO}_{4 / 2}$$

wherein
R¹¹, R¹², R¹³, R¹⁴, R¹⁵, R¹⁶ are independently of each other identical or different hydrocarbon radicals having 1 to 12, preferably 1 to 8, carbon atoms, wherein the hydrocarbon radicals are optionally substituted with heteroatoms or H, in particular phenyl-, CH₃—, CH₃CH₂—, CH₂CH— ClCH₂CH₂CH₂— or H—,
and wherein

$$a = 2 to 6$$

$$b = 0 to 8$$

$$c = 0 to 4$$

$$d = 0 to 2 ,$$

with the proviso that a+b+c+d<20, preferably <15, especially preferably <11, wherein it is particularly preferable when
R¹⁶ is different from R¹¹, R¹², R¹³, R¹⁴ and R¹⁵,
and/or R¹¹, R¹² and R¹³ are different.

It is further preferable when the altogether employed organic compound V is employed in a total amount of 0.1 to 10 parts by mass, preferably 0.5 to 5 parts by mass, particularly preferably 1 to 3 parts by mass, based on 100 parts by mass of the total polyol component.

It is preferable to employ mixtures of at least one hydrocarbon HC, at least one polyalkylsiloxane PAS and at least one organic compound V, particularly preferably together with carrier media. Examples of optional carrier media include for example glycols, alkoxylates and/or oils of synthetic and/or natural origin.

It is preferable when the total mass fraction of organic compound V, optional hydrocarbon HC and optional polyalkylsiloxane PAS in the finished polyurethane foam is from 0.01% to 10% by weight, preferably from 0.1% to 3% by weight, based on the finished polyurethane foam.

It is preferable when the at least one organic compound V is employed together with at least one polyalkylsiloxane PAS an/or at least one hydrocarbon HC. It is preferable when the hydrocarbons HC and/or polyalkylsiloxanes PAS are employed in the composition according to the invention in combination with the organic compound V in a mass ratio of 1:4 to 1:200. The mass ratio is the ratio of the mass of the entirety of all hydrocarbons HC and/or polyalkylsiloxanes PAS to the mass of the entirety of all organic compounds V in the composition according to the invention.

Preferred quantity ratios, based only on the ratio of organic compound V, optional hydrocarbon HC and/or optional polyalkylsiloxane PAS relative to one another may be for example as follows:
altogether employed organic compound V: 80 to 99.5 parts by weight,
altogether optionally employed hydrocarbon HC: 0.5 to 20 parts by weight,
altogether optionally employed polyalkylsiloxane PAS: 0.5 to 20 parts by weight,
wherein for this exemplary treatment the parts by weight of altogether employed organic compound V, altogether employed hydrocarbon HC and altogether employed polyalkylsiloxane PAS sum to 100 parts by weight.

As described above the composition according to the invention may contain at least one hydrocarbon HC. When hydrocarbon HC is present it is preferable when the total amount of altogether employed hydrocarbon HC, altogether employed organic compound V and optionally altogether employed polyalkylsiloxane PAS based on 100 parts by mass of the total polyol component is preferably from 0.1 to 10 parts by mass, preferably 0.5 to 5 parts by mass and particularly preferably 1 to 3 parts by mass.

The composition according to the invention may preferably further include at least one polyether-modified siloxane (PES). When polyether-modified siloxane (PES) is present it is preferable when the at least one polyether-modified siloxane based on 100 parts by mass of the total polyol component is preferably employed in a total amount of 0.1 to 10 parts by mass, preferably 0.5 to 5 parts by mass, particularly preferably 1 to 3 parts by mass.

As elucidated above the composition according to the invention for producing polyurethane foam comprises a polyisocyanate component, a polyol component, optionally at least one catalyst that catalyses the formation of a urethane or isocyanurate bond and optionally at least one blowing agent, wherein the composition additionally comprises at least one organic compound V as described above.

It is preferable when the composition according to the invention is a composition for producing rigid PU foam, preferably closed-cell rigid PU foam.

It is preferable when the ratio of altogether employed polyisocyanate component and altogether employed polyol component expressed as the index of the formulation, i.e. as the stoichiometric ratio of isocyanate groups to isocyanate-reactive groups multiplied by 100, is in the range from 150 to 550, particularly preferably 200 to 500.

It is preferable when the altogether employed polyol component comprises at least one polyester polyol, preferably having melting points below 30° C., wherein the usage amount of the altogether employed polyester polyol based on 100 parts by mass of the total polyol component is by preference from 20 to 100 parts by mass, preferably from 40 to 99 parts by mass and particularly preferably from 70 to 98 parts by mass.

It is preferable when the composition according to the invention comprises at least one blowing agent, preferably comprises as blowing agent at least one hydrocarbon having 4 or 5 carbon atoms, in particular having 5 carbon atoms, wherein the composition preferably comprises no halogenated blowing agents.

A particularly preferred composition according to the invention comprises the following constituents:
a polyol component,
a polyisocyanate component,
at least one organic compound V,
optionally at least one catalyst,
optionally at least one blowing agent
optionally further additives, preferably selected from the group consisting of fillers and flame retardants.

As already described above a particularly preferred composition according to the invention may preferably further comprise at least one hydrocarbon HC, at least one polyalkylsiloxane PAS and/or at least one polyether-modified siloxane (PES).

It is preferable when the total usage amount of at least one organic compound V, at least one hydrocarbon HC, optionally at least one polyalkylsiloxane PAS and optionally at least one polyether-modified siloxane (PES) by preference sums to from 0.1 to 10 parts by mass, preferably from 0.5 to 5 parts by mass and particularly preferably from 1 to 3 parts by mass based on 100 parts by mass of the total polyol component.

The polyol component consists of at least one polyol and optionally at least one organic compound containing at least two isocyanate-reactive groups, preferably selected from the group consisting of OH, NH and NH₂ groups. Polyols are organic compounds containing at least two hydroxyl groups (—OH). If one of the above-mentioned organic compounds of the polyol component contains at least two OH groups, then this is exclusively assigned to the polyols for the purposes of the invention. This means that if an organic compound of the polyol component can be assessed as being both a polyol and an organic compound containing at least two isocyanate-reactive groups, preferably selected from the group consisting of OH, NH and NH₂ groups, then it is assigned exclusively to the polyols for the purposes of the invention. Based on its total weight, the polyol component preferably contains at least 50% by weight of those polyols containing only hydroxyl groups (—OH) as isocyanate-reactive groups.

Based on the total number of isocyanate-reactive groups in the polyol component, it is preferable that at least 50% of these be hydroxyl groups (—OH).

Appropriate compounds which may typically be used when producing PU are known to those skilled in the art and for example described in “Kunststoffhandbuch, Band 7, Polyurethane [Plastics Handbook, volume 7, Polyurethanes]”, Carl Hanser Verlag, 3rd Edition 1993, Chapter 3.1. It is customary to employ compounds having OH numbers preferably in the range from 10 to 1200 mg KOH/g. Particularly preferred compounds are all polyether polyols and polyester polyols typically used for production of polyurethane systems, especially polyurethane foams. Polyether polyols can preferably be obtained by reacting polyfunctional alcohols or amines with alkylene oxides. Polyester polyols are preferably based on esters of polybasic carboxylic acids (which may be either aliphatic, as in the case of adipic acid for example, or aromatic, as in the case of phthalic acid or terephthalic acid, for example) with polyhydric alcohols (preferably glycols).

Also employable in addition are for example polyetherpolycarbonate polyols, polyols based on natural oils (natural oil based polyols, NOPs, described for example in WO 2005/033167, US 2006/0293400, WO 2006/094227, WO 2004/096882, US 2002/0103091, WO 2006/116456, EP 1678232), filled polyols, prepolymer-based polyols and/or recycled polyols.

Recycled polyols are polyols that are obtained from the chemical recycling of polyurethanes, for example by solvolysis, for example glycolysis, hydrolysis, acidolysis or aminolysis.

Typically employable polyols are compounds having OH numbers preferably in the range from 10 to 1200 mg KOH/g. The OH number is preferably determined either in accordance with the standard DIN EN ISO 4629-1:2016-12 (without catalyst) or in accordance with the standard DIN EN ISO 4629-2:2016-12 (with catalyst).

It is preferable for the polyols or the polyol component to have a number-average molecular weight from 500 to 15 000 g/mol. The number-average molecular weight may be determined for example by gel permeation chromatography (GPC), preferably according to the standard DIN EN ISO 13885-1:2021-11 (THF as eluent), according to the standard DIN EN ISO 13885-2:2021-11 (acrylamide as eluent) or according to the standard ISO 13885-3:2020-07 (water as eluent), particularly preferably according to DIN EN ISO 13885-1:2021-11 (THF as eluent).

The polyisocyanate component consists of at least one polyisocyanate having two or more isocyanate groups. Suitable polyisocyanates for the purposes of the present invention are all organic isocyanates having two or more isocyanate groups, in particular the aliphatic, cycloaliphatic, arylaliphatic and preferably aromatic polyfunctional isocyanates known per se. Examples that may be mentioned here are alkylene diisocyanates having 4 to 12 carbon atoms in the alkylene radical, for example dodecane 1,12-diisocyanate, 2-ethyltetramethylene 1,4-diisocyanate, 2-methylpentamethylene 1,5-diisocyanate, tetramethylene 1,4-diisocyanate, pentamethylene diisocyanate (PDI) and preferably hexamethylene 1,6-diisocyanate (HMDI), cycloaliphatic diisocyanates such as cyclohexane 1,3- and 1,4-diisocyanate and the corresponding isomer mixtures, methylene dicyclohexyl 4,4′-diisocyanate (H12MDI), isophorone diisocyanate (IPDI), methylcyclohexyl 2,4- and 2,6-diisocyanate and the corresponding isomer mixtures, and preferably aromatic diisocyanates and polyisocyanates such as toluene 2,4- and 2,6-diisocyanate (TDI) and the corresponding isomer mixtures, naphthylene diisocyanate, diethyltoluene diisocyanate, diphenylmethane 4,4′- or 2,2′- or 2,4′-diisocyanate (MDI) and polymethylene polyphenyl polyisocyanate (PMDI, “polymeric MDI”). The organic polyisocyanates may be used individually or in the form of mixtures thereof. It is likewise possible to use corresponding “oligomers” of the diisocyanates, such as the IPDI trimer based on the isocyanurate, biurets or uretdiones. Furthermore, the use of prepolymers based on the abovementioned isocyanates is possible. The mixture of MDI and more highly condensed analogues having an average functionality of 2 to 4 which is known as polymeric MDI (also referred to as “crude MDI”) is particularly suitable, as are the various isomers of TDI in pure form or as isomer mixture. It is also possible to use isocyanates which have been modified by the incorporation of urethane, uretdione, isocyanurate, allophanate and other groups, known as modified isocyanates. Examples of particularly suitable isocyanates are detailed for example in EP 1712578, EP 1161474, WO 00/58383, US 2007/0072951, EP 1678232 and WO 2005/085310, which are hereby fully incorporated by reference.

A preferred ratio of polyisocyanate component and polyol component, expressed as the index of the formulation (isocyanate index), i.e. as the stoichiometric ratio of isocyanate groups to isocyanate-reactive groups (e.g. OH groups, NH groups) multiplied by 100, is in the range from 10 to 1000 and preferably 40 to 400. An index of 100 represents a molar ratio of reactive groups of 1:1.

In a particularly preferred embodiment of the invention the index of the formulation is preferably in the range from 150 to 550, particularly preferably 200 to 500. That is to say that in a particularly preferred embodiment a marked excess of isocyanate groups to isocyanate-reactive groups is preferably present. This results in trimerization reactions of the isocyanates, which thus form isocyanurates. These foam types may also be referred to as polyisocyanurate (PIR) foams and feature improved fire characteristics, i.e. poorer burning. In the context of the present invention PIR foams are encompassed by the generic term PU foam and are particularly preferred. It is particularly preferable when the polyol component comprises one or more polyester polyols.

The composition according to the invention may optionally comprise at least one catalyst that catalyses the formation of a urethane or isocyanurate bond. Suitable catalysts which are usable for the production of polyurethanes, in particular PU foams, are known to those skilled in the art from the prior art.

These may catalyse the formation of a urethane or isocyanurate bond or catalyse the isocyanate-polyol and/or isocyanate-water and/or isocyanate trimerization reactions. Usable compounds in the context of the present invention are preferably all compounds capable of catalysing the reaction of isocyanate groups with OH groups, NH groups or other isocyanate-reactive groups, and/or the reaction of isocyanate groups with one another. It is preferable to use the customary catalysts known from the prior art, for example amines (cyclic, acyclic; monoamines, diamines, oligomers having one or more amino groups), ammonium compounds, organometallic compounds and/or metal salts, preferably those of iron, bismuth, potassium and/or zinc. In particular, catalysts used may be mixtures of two or more compounds of this kind. Suitable use amounts depend on the type of catalyst and can preferably be in the range from 0.05 to 5 pphp (=parts by weight based on 100 parts by weight of polyol) for example in the case of amine catalysts, or preferably be in the range from 0.1 to 10 pphp for example in the case of potassium salts.

Foam stabilizers and the use thereof in the production of PU foams are known to those skilled in the art as described above. The composition according to the invention contains at least one organic compound V as foam stabilizer.

Preferably employable in addition to the at least one organic compound V are one or more further foam stabilizers, for example polyether siloxane foam stabilizers, as described for example in CN 103665385, CN 103657518, CN 103055759, CN 103044687, US 2008/0125503, US 2015/0057384, EP 1520870 A1, EP 1211279, EP 0867464, EP 0867465 or EP 0275563, and/or for example further Si-free surfactants. By way of example, EP 2295485 A1 describes the use of lecithin and for example U.S. Pat. No. 3,746,663 the use of vinylpyrrolidone-based structures. Further Si-free foam stabilizers are described for example in EP 2511328 B1, DE 1020011007479 A1, DE 3724716 C1, EP 0734404, EP 1985642, DE 2244350 and U.S. Pat. No. 5,236,961.

Also preferably employable are hydrocarbons HC, polyalkylsiloxanes PAS, Si-free surfactants and/or optionally polyether-modified siloxanes (PES).

Blowing agents and the use thereof in the production of PU foams are known to those skilled in the art, wherein the use thereof is optional in the context of the invention and at least one blowing agent may be employed with preference. The preferred use of a blowing agent or of a combination of two or more blowing agents preferably depends on the nature of the foaming process, on the nature of the system and on the application of the obtained PU foam. Both chemical and/or physical blowing agents may be used, as well as a combination of the two. A foam of relatively high or relatively low density may be produced for example according to the amount of the employed blowing agent. It is thus possible for example to produce foams having densities of 5 kg/m³ to 900 kg/m³, preferably 5 to 350 kg/m³, particularly preferably 8 to 200 kg/m³, especially 8 to 150 kg/m³.

Optionally employable physical blowing agents include for example one or more of the appropriate compounds having suitable boiling points, for example hydrocarbons having 3, 4 or 5 carbon atoms, preferably cyclo-, iso-, or n-pentane, hydrofluorocarbons (HFCs), such as for example HFC 245fa, HFC 134a or HFC 365mfc, hydrochlorofluorocarbons (HCFCs), such as for example HCFC 141b, hydrofluoroolefins (HFOs) or hydrohaloolefins, preferably 1234ze, 1234yf, 1224yd, 1233zd(E) or 1336mzz, esters, preferably methyl formate, ketones, preferably acetone, ethers, preferably dimethoxymethane, or chlorinated hydrocarbons, such as for example dichloromethane or 1,2-dichloroethane, and also mixtures thereof.

Optionally employable chemical blowing agents include for example one or more compounds that either react with NCO groups to release gases, for example water or formic acid, or release gases during the reaction as a result of the temperature increase, for example sodium hydrogencarbonate.

It is particularly preferable when the composition according to the invention contains as blowing agent water in combination with hydrocarbons having 5 carbon atoms, HFO, hydrohaloolefins or HFC or mixtures thereof.

Preference is given to the use of hydrocarbons having 4 or 5 carbon atoms.

Suitable water contents in the context of the present invention preferably depend on whether or not one or more blowing agents are used in addition to the water. It is preferably when in purely water-blown foams preferred values are for example 1 to 20 parts by mass of water based on 100 parts by mass of polyol. If other blowing agents are additionally employed the preferred usage amount is preferably reduced to for example 0.1 to 5 parts by mass of water based on 100 parts by mass of polyol.

As optional additives, it is possible for example to use one or more of the substances which are known from the prior art and are used in the production of polyurethanes, especially PU foams, for example crosslinkers, chain extenders, stabilizers against oxidative degradation (known as antioxidants), flame retardants, biocides, cell-refining additives, nucleating agents, cell openers, solid fillers, antistatic additives, thickeners, dyes, pigments, colour pastes, fragrances, and/or emulsifiers, etc.

As optional flame retardant the composition according to the invention may contain for example one or more of the known flame retardants suitable for the production of PU foams, for example halogen-containing or halogen-free organic phosphorus-containing compounds, for example triethyl phosphate (TEP), tris(1-chloro-2-propyl) phosphate (TCPP), tris(2-chloroethyl) phosphate (TCEP), dimethyl methanephosphonate (DMMP), dimethyl propanephosphonate (DMPP), diethyl(hydroxymethyl) phosphonate, ammonium polyphosphate or red phosphorus, nitrogen-containing compounds, for example melamine, melamine cyanurate or melamine polyphosphate, or halogenated compounds, for example chlorinated and/or brominated polyether polyols and/or polyester polyols. It is also possible to use mixtures of different flame retardants.

Unless the opposite is apparent from this description, it is possible to combine any preferred or particularly preferred embodiment of the invention with one or more of the other preferred or particularly preferred embodiments of the invention.

The invention further provides a process for producing polyurethane foam by reacting a polyol component with a polyisocyanate component, wherein the reaction is carried out in the presence of at least one organic compound V as described above, preferably as defined in any of embodiments 1 to 4, preferably using a composition as described above, particularly preferably using a composition according to any of embodiments 1 to 12.

The process according to the invention for producing PU foam may be performed by any known methods, for example by manual mixing or preferably using foaming machines. If the process is performed using foaming machines these may be high-pressure or low-pressure machines. The process according to the invention can be performed either discontinuously or continuously and it is possible for example to use 1K, 1.5K or 2K systems as described for example in EP3717538 A1, U.S. Pat. No. 7,776,934 B2, EP1400547 B1 or EP2780384 B2.

A preferred polyurethane foam formulation in the context of the present invention results in a foam density of 5 to 900 kg/m³ and preferably has the composition shown in Table 1.

TABLE 1
Composition of a preferred polyurethane foam formulation

| | Parts by |
|---|---|
| Component | weight |
| Polyol | 70 to 100 |
| Amine catalyst | 0 to 5 |
| Metal catalyst | 0 to 10 |
| Organic compound V and preferably also polyalkyl- | 0.1 to 10 |
| siloxane PAS, hydrocarbon HC and/or polyether-modified | |
| siloxane (PES) | |
| Water | 0.01 to 20 |
| Blowing agent | 0.1 to 40 |
| Further additives (flame retardants etc.) | 0 to 40 |
| Isocyanate index: 70 to 600 | |

For further preferred embodiments and configurations of the process according to the invention, reference is also made to the details previously given above in connection with the composition according to the invention. These details are preferably applicable.

The invention further provides a polyurethane foam obtainable by the process according to the invention.

It is preferable when the polyurethane foam has a foam density of 5 to 900 kg/m³, more preferably 8 to 800 kg/m³, yet more preferably 10 to 600 kg/m³, especially 30 to 150 kg/m³.

It is preferable when the polyurethane foam has a lambda value of less than 25, more preferably less than 24, yet more preferably less than 23, in particular less than 22, mW/m·K. The lambda values are measured 24 hours after foaming on samples measuring 20×20×2.5 cm. The lambda value was determined according to DIN EN 12667: 2001-05 at an average temperature of 10° C.

The polyurethane foam (PU foam) according to the invention is preferably a rigid polyurethane foam (rigid PU foam), particularly preferably closed-cell rigid PU foam. “Rigid polyurethane foam” or “rigid PU foam” is an established technical term. The known and fundamental difference between flexible foam and rigid foam is that flexible foam exhibits elastic behaviour and deformation is thus reversible. By contrast, rigid foam undergoes permanent deformation. In the context of the present invention rigid polyurethane foam is preferably to be understood as meaning a foam according to DIN 7726:1982-05 that preferably has a compressive strength according to DIN 53421:1984-06/DIN EN ISO 844:2014-11 of ≥20 kPa, preferably ≥80 kPa, more preferably ≥100 kPa, yet more preferably ≥150 kPa, particularly preferably ≥180 kPa. The rigid polyurethane foam preferably has a closed cell content of more than 50%, preferably more than 80% and particularly preferably more than 90%, wherein the closed cell content is preferably determinable according to DIN EN ISO 4590:2016-12. Further details regarding rigid polyurethane foams can also be found in “Kunststoffhandbuch, Band 7, Polyurethane [Plastics Handbook, volume 7, Polyurethanes]”, Carl Hanser Verlag, 3rd Edition 1993, Chapter 6.

The PU foams, especially rigid PU foams, according to the invention may preferably be used for example as or for production of insulation materials, preferably insulation panels, refrigerators, insulating foams, headliners, packaging foams or spray foams.

The present invention thus further provides for the use of the polyurethane foam according to the invention as insulation panels and/or insulant, preferably for refrigeration apparatuses. The refrigeration apparatuses preferably include the polyurethane foam according to the invention as insulation material.

The PU foams according to the invention may be advantageously employed especially in the refrigerated warehouse, refrigeration apparatus and domestic appliances industries, for example for production of insulation panels for roofs and walls, as insulation material in containers and warehouses for frozen goods and for refrigeration and freezing apparatuses.

Further preferred fields of application are in vehicle construction, especially for production of vehicle headliners, body parts, interior trim, refrigerated vehicles, large containers, transport pallets, packaging laminates, in the furniture industry, for example for furniture parts, doors, claddings, and in electronics applications.

PU foams according to the invention are preferably employable as insulation material for refrigeration apparatuses.

The invention further provides for the use of the PU foam as insulation material in refrigeration technology, in refrigeration equipment, in the construction sector, automobile sector, shipbuilding sector and/or electronics sector, as insulating panels, as spray foam and as one-component foam.

The invention further provides for the use of at least one organic compound V, as described above, preferably as defined in any of embodiments 1 to 4, preferably in combination with at least one hydrocarbon HC as described above, preferably as defined in embodiment 5, and optionally comprising at least one polyalkylsiloxane PAS as described above, preferably as defined in embodiment 6 or 7, in the production of polyurethane foams, preferably as foam stabilizer, preferably for improving the insulation properties of the polyurethane foam, particularly preferably using a composition according to the invention as described above, preferably an inventive composition according to any of embodiments 1 to 12, especially for providing polyurethane foam having lambda values of less than 25, 24 or 23 mW/m K.

Where ranges, general formulae or classes of compounds are reported, these are intended to encompass not only the corresponding ranges or groups of compounds explicitly mentioned but also all subranges and subgroups of compounds obtainable by selecting individual values (ranges) or compounds. Where documents are cited in the context of the present description, the entire content thereof, particularly with regard to the subject matter that forms the context in which the document has been cited, is intended to form part of the disclosure content of the present invention. Unless otherwise stated, reported percentages are percentages by weight. Where average values are reported these are weight-averages unless otherwise stated. Where parameters determined by measurement are reported the measurements have been carried out at a temperature of 25° C. and preferably at a pressure of 1.01325 bar (standard pressure) unless otherwise stated.

The following examples are used for further exemplary elucidation of the present invention but the present invention is not limited to the following examples.

### Examples

The following organic compounds V were employed:
V 1: Staybelite™ Ester 3-E: Triethylene glycol ester of abietic acid from Eastman Chemical Company
V 2: Abitol™ E: Hydrogenated abietol from Eastman Chemical Company
V 3: Hydrogral®: Abietic acid—lightly hydrogenated from DRT (Les Dérives Résiniques et Terpéniques, 30 Rue Gambetta, 40100 Dax, France)
V 4: Hercolyn® D: Methyl ester of hydrogenated abietic acid from DRT
V 5: Staybelite™ Ester 10-E: Glycerol ester of abietic acid from Eastman Chemical Company
V 6: Dertoline® DEG: Diethylene glycol esters of abietic acid from DRT
V 7: Granolite® TEG: Triethylene glycol ester of abietic acid from DRT

The following material was used as hydrocarbons HC:

HC-A: Oxo oil LS 13 from Evonik Operations GmbH, Oxo oil LS 13 is a C12-rich hydrocarbon mixture having a high olefin content which is generated as a high-boiler fraction in the production of isotridecanol by the oxo alcohol process.

The following material was used as polyalkylsiloxane PAS:

PAS A: Trisiloxane with octyl side chain corresponding to formula 1 from WO2021/144033 A1 with Mₐ D_{b} T_{c} Q_{d}, wherein a=2; b=1; c=0; d=0; R¹¹=methyl; R¹²=methyl; R¹³=methyl; R¹⁴=octyl, R¹⁵=methyl; as described as PAS no. 5 in WO 2020/144003 A1.

The employed polyether-modified siloxane (PES) was TEGOSTAB® B 84507 from Evonik Operations GmbH, also referred to below as B 84507 for short.

The following comparative substances were used:

Oleo no. 1: Diethanolamide based on soybean oil and diethanolamine, produced as described in DE 102011007479 A1 in example 1b as amide 2.

Oleo no. 2: Sorbitan monolaurate, commercially available as TEGO® SML from Evonik Operations GmbH

The foaming experiments for producing rigid PU foams employed the organic compounds V, as is in each case apparent from table 4, for example also in admixture with the hydrocarbon HC A or polyalkylsiloxane PAS A and/or together with the polyether-modified siloxane (PES).

This was done using the following mixtures that are summarized in Table 2.

TABLE 2
Description of the organic compound V/PAS and V/HC mixtures

| | | | | PAS A |
|---|---|---|---|---|
| | Organic | V | HC A | % by |
| | compound V | % by wt. | % by wt. | wt. |
| Mixture 1 | V 1 | 90 | 10 | |
| Mixture 2 | V 1 | 90 | | 10 |
| Mixture 3 | V 2 | 90 | 10 | |
| Mixture 4 | V 3 | 90 | 10 | |
| Mixture 5 | V 4 | 90 | 10 | |
| Mixture 6 | V 5 | 90 | 10 | |
| Mixture 7 | V 6 | 90 | 10 | |
| Mixture 8 | V 7 | 90 | 10 | |

Foams were produced using the following raw materials:
Stepanpol® PS 2412: polyester polyol from Stepan
TCPP: tris(2-chloroisopropyl) phosphate from Fyrol (flame retardant)
POLYCAT® 5 from Evonik Operations GmbH, amine-based catalyst
Kosmos® 70 LO from Evonik Operations GmbH, catalyst based on potassium octoate
MDI (44V20): Desmodur® 44V20L from Covestro, diphenylmethane 4,4′-diisocyanate (MDI) with isomeric and higher-functionality homologues.

Foaming was carried out by manual mixing. To this end, all components according to table 3 except for the polyisocyanate (MDI) were weighed into a beaker and mixed using a disc stirrer (diameter 6 cm) at 1000 rpm for 30 s. The beaker was reweighed to determine the amount of blowing agent that had evaporated during the mixing operation and this was replenished. Subsequently, the polyisocyanate (MDI) was added, and the reaction mixture was stirred with the stirrer described at 3000 rpm for 5 s.

In the case of the presently employed foam formulations for panel applications, for example buildings insulation, the mixture was immediately introduced into an aluminium mould measuring 50 cm×25 cm×7 cm which had been thermostated to 65° C.

The usage amount of foam formulation was such that the amount was sufficient for minimum filling of the mould. The foams were demoulded after 10 minutes and then stored at room temperature for 24 hours.

A cut surface in the foam was used to visually assess the degree of internal defects and the pore structure on a scale from 1 to 10, where 10 represents an impeccable foam and 1 a very significantly defective foam.

The thermal conductivity coefficient (k value in mW/m-K) was measured on 2.5 cm-thick discs after one day (1 d) and after 7 days (7 d) with a Hesto Lambda Control HLC X206 instrument at an average temperature of 10° C. as specified in the standard EN 12667:2001-05.

Table 3 summarizes the foam formulation used for the examples.

TABLE 3
(figures in parts by weight)

Formulation

| | |
|---|---|
| Stepanpol ® PS 2412 | 100 |
| KOSMOS ® 70 LO | 3 |
| Polycat ® 5 | 0.5 |
| either mixture containing V, HC or PAS and optionally PES or | 3 |
| V alone | |
| TCPP | 15 |
| Water | 0.5 |
| Isopentane | 4.5 |
| Cyclopentane | 10.4 |
| MDI (44V20) | 180 |

The results of the foaming experiments are summarized in table 4. As described above, panels were produced and the lambda values (in mW/m·K) were measured after 1 day and 7 days, and the internal defects evaluated on a scale from 1-10. The lower the lambda value, the better the insulation performance.

TABLE 4
Results of the foaming experiments

| Foam | | parts by | | PES parts | | | Internal |
|---|---|---|---|---|---|---|---|
| Example | Additive | wt. | PES | by wt. | Lambda-1d | Lambda-7d | defects |
| Comp. ex. 1 | | | B 84507 | 3 | 21.1 | 23.7 | 7 |
| Comp. ex. 2 | | | B 84507 | 1 | 21.6 | 23.9 | 7 |
| Comp. ex. 3 | Oleo no. 1: | 3 | | | 22.9 | 26.2 | 7.5 |
| Comp. ex. 4 | Oleo no. 2: | 3 | | | 22.7 | 26.3 | 8 |
| 1 | Mixture no. 1 | 3 | | | 21.0 | 24.4 | 7 |
| 2 | Mixture no. 2 | 3 | | | 20.8 | 24.2 | 7 |
| 3 | V 1 | 3 | | | 25.5 | 32.8 | 7 |
| 4 | Mixture no. 3 | 3 | | | 21.1 | 24.5 | 6.5 |
| 5 | V 2 | 3 | | | 21.5 | 24.2 | 6.5 |
| 6 | Mixture no. 4 | 3 | | | 23.0 | 28.9 | 3 |
| 7 | V 3 | 3 | | | 25.0 | 30.5 | 3 |
| 8 | Mixture no. 5 | 3 | | | 21.6 | 26.0 | 6 |
| 9 | V 4 | 3 | | | 23.2 | 26.5 | 6 |
| 10 | Mixture no. 2 | 2 | B 84507 | 1 | 19.9 | 22.7 | 7 |
| 11 | V 1 | 2 | B 84507 | 1 | 21.0 | 23.5 | 7 |
| 12 | Mixture no. 3 | 2 | B 84507 | 1 | 20.0 | 23.2 | 7 |
| 13 | V 2 | 2 | B 84507 | 1 | 21.2 | 23.7 | 6.5 |
| 14 | Mixture no. 6 | 2 | B 84507 | 1 | 20.9 | 26.0 | 7 |
| 15 | V 5 | 2 | B 84507 | 1 | 22.2 | 25.2 | 6 |
| 16 | Mixture no. 7 | 2 | B 84507 | 1 | 20.7 | 24.1 | 6.5 |
| 17 | V 6 | 2 | B 84507 | 1 | 22.2 | 25.7 | 7 |
| 18 | Mixture no. 8 | 2 | B 84507 | 1 | 20.3 | 24.3 | 7 |
| 19 | V 7 | 2 | B 84507 | 1 | 21.7 | 24.2 | 7 |
| 20 | Mixture no. 4 | 2 | B 84507 | 1 | 20.2 | 25.9 | 6.5 |
| 21 | V 3 | 2 | B 84507 | 1 | 21.5 | 25.3 | 7 |
| 22 | Mixture no. 5 | 2 | B 84507 | 1 | 20.3 | 23.7 | 6.5 |
| 23 | V 4 | 2 | B 84507 | 1 | 22.1 | 25.2 | 6.5 |

It is apparent from the experiments that the inventive organic compounds V and mixtures containing V in some cases even resulted in foam qualities that are comparable with or better than the foams produced with olio surfactants or polyether-modified siloxanes (PES).

Thus, V2 (experiment no. 5) achieved better results, i.e. lower lambda values, than the oleo candidates (comparative experiments 3 and 4). The other compounds V, without additions of HC or PAS (experiments 3, 7 and 9), recorded higher lambda values compared to comparative experiments 3 and 4.

The mixtures with HC or PAS and compounds V in some cases even showed particularly improved foam properties. This is apparent from:
Examples 1 and 2 compared to example 3
Example 6 compared to example 7
Example 8 compared to example 9

The experiments in which compounds V were combined with PES or V/HC or V/PAS with PES show that in most cases combinations lead to better lambda values than PES alone. Accordingly, experiments 10, 11, 12, 14, 16, 18, 20 and 22 achieved lower lambda values after 1 day than examples comp. ex 1 or comp. ex 2.

1. A composition for producing polyurethane foam, the composition, comprising:
a polyisocyanate component,
a polyol component,
optionally at least one catalyst that catalyses a formation of a urethane or isocyanurate bond, and
optionally at least one blowing agent,
wherein the composition additionally comprises at least one organic compound V comprising at least one radical R^{A} selected from the group consisting of 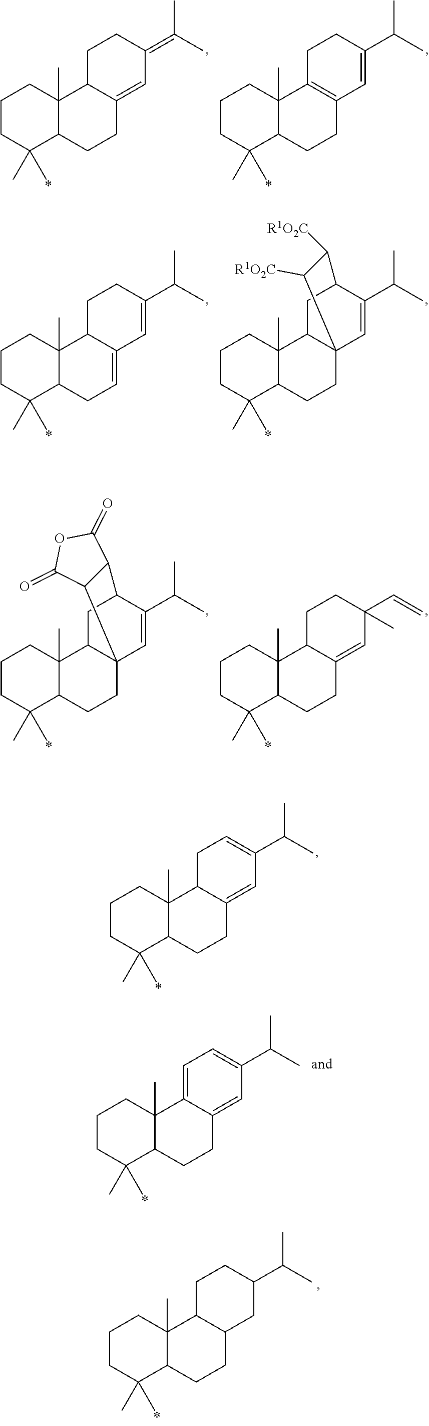
wherein * denotes a bond to a remaining portion of the at least one organic compound V,
and wherein
R¹ are independently of one another identical or different and selected from H or branched or linear alkyl radicals having 1 to 30 carbon atoms which optionally also contain heteroatoms.

2. The composition according to claim 1, wherein the at least one organic compound V is selected from the group consisting of 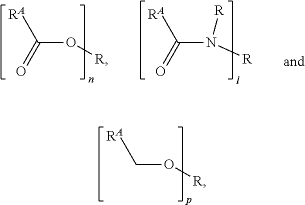
wherein
$$n = 1 to 5 ,$$
$$l = 1 to 5 ,$$
$$p = 1 to 5 ,$$
R are independently of one another identical or different and selected from H or branched or linear alkyl radicals having 1 to 30 carbon atoms which optionally also contain heteroatoms,
R^{A} are independently of one another identical or different radicals selected from the group consisting of 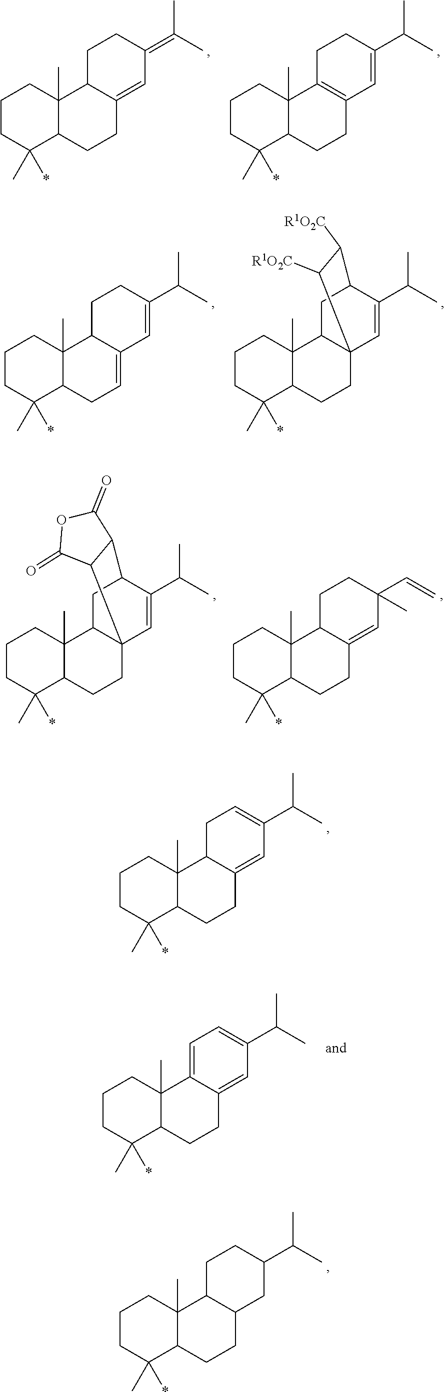
wherein * denotes the bond to the remaining portion of the at least one organic compound V,
and wherein
R¹ are independently of one another identical or different and selected from H or branched or linear alkyl radicals having 1 to 30 carbon atoms which optionally also contain heteroatoms.

3. The composition according to claim 1, wherein the at least one organic compound V is selected from the group consisting of 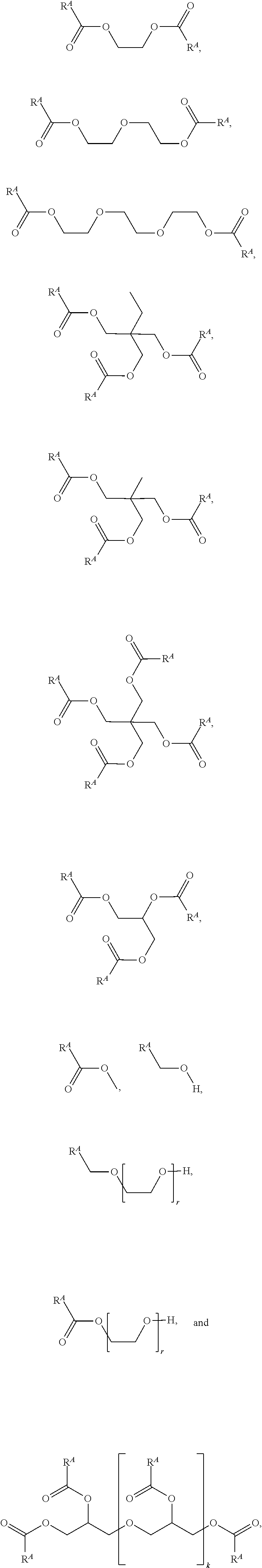
wherein
R^{A} are independently of one another identical or different radicals selected from the group consisting of 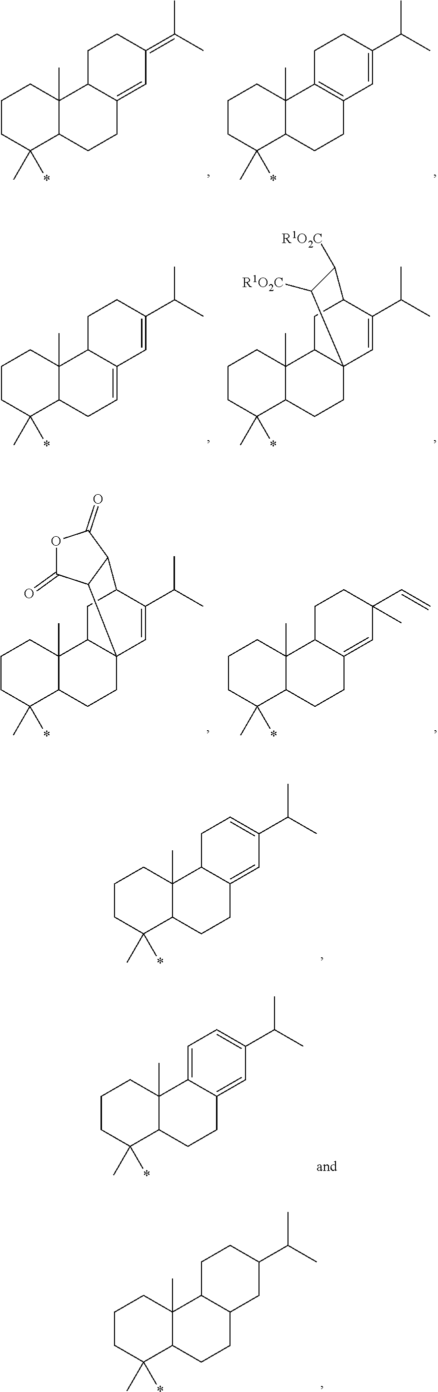
wherein * denotes the bond to the remaining portion of the organic compound V and wherein
$$m = 1 to 15 ,$$
$$r = 1 to 15 ,$$
$$k = 1 to 6 ,$$
R¹ are independently of one another identical or different and selected from H or branched or linear alkyl radicals having 1 to 30 carbon atoms which optionally also contain heteroatoms.

4. The composition according to claim 1, wherein the at least one organic compound V has an OH number of less than 150 mg KOH/g.

5. The composition according to claim 1, further comprising:
at least one hydrocarbon HC having 10 to 24 carbon atoms and a boiling point>100° C. at a pressure of 1.01325 bar,
wherein altogether present hydrocarbon HC in combination with altogether present organic compound V are employed in a mass ratio of 1:5 to 1:200.

6. The composition according to claim 1, further comprising:
at least one polyalkylsiloxane PAS which comprises no polyether modification and contains less than 20 Si atoms,
wherein altogether employed polyalkylsiloxane PAS is employed in a mass ratio of 1:4 to 1:200 based on altogether employed organic compound V and
the at least one polyalkylsiloxane PAS conforms to formula 1:
$${M}_{a} {D}_{b} {T}_{c} {Q}_{d} \qquad ( formula 1 )$$
where
$$M = {R}^{11} {R}^{12} {R}^{13} {SiO}_{1 / 2}$$
$$D = {R}^{14} {R}^{15} {SiO}_{2 / 2}$$
$$T = {R}^{16} {SiO}_{3 / 2}$$
$$Q = {SiO}_{4 / 2}$$
wherein
R¹¹, R¹², R¹³, R¹⁴, R¹⁵, R¹⁶ are independently of one another identical or different hydrocarbon radicals having 1 to 12 carbon atoms, wherein the hydrocarbon radicals are optionally substituted with heteroatoms or H,
and wherein
$$a = 2 to 6$$
$$b = 0 to 8$$
$$c = 0 to 4$$
$$d = 0 to 2 ,$$
with the proviso that a+b+c+d<20,
wherein
R¹⁶ is different from R¹¹, R¹², R¹³, R¹⁴ and R¹⁵,
and/or R¹¹, R¹² and R¹³ are different.

7. The composition according to claim 1, wherein an usage amount of the altogether employed organic compound V based on 100 parts by mass of the total polyol component is from 0.1 to 10 parts by mass.

8. The composition according to claim 5, wherein an usage amount of altogether employed hydrocarbon HC, altogether employed organic compound V and optionally altogether employed polyalkylsiloxane PAS based on 100 parts by mass of the total polyol component is from 0.1 to 10 parts by mass.

9. The composition according to claim 1, further comprising:
at least one polyether-modified siloxane.

10. The composition according to claim 1, wherein a ratio of altogether employed polyisocyanate component and altogether employed polyol component expressed as an index of a formulation is in the range from 150 to 550.

11. The composition according to claim 1, wherein the altogether employed polyol component comprises at least one polyester polyol.

12. The composition according to claim 1, comprising:
at least one blowing agent.

13. A process for producing polyurethane foam by reacting a polyol component with a polyisocyanate component, the process comprising:
carrying out the reaction in presence of at least one organic compound V as defined in claim 1.

14. A polyurethane foam obtainable by the process according to claim 13.

15. A composition for insulation purposes, the composition comprising:
The polyurethane foam according to claim 14.

16. A process, comprising:
producing a polyurethane foam with the at least one organic compound V as defined in claim 1.
